(19) United States
(12) Patent Application Publication
(10) Pub. No.: US 2025/0246083 A1
(43) Pub. Date: Jul. 31, 2025

(54) SYSTEMS AND METHODS FOR AIRCRAFT RUNWAY/TAXIWAY INTERSECTION TAKEOFF ASSESSMENT

(71) Applicant: HONEYWELL INTERNATIONAL INC., Charlotte, NC (US)

(72) Inventors: Nathan Krishna Moorthy, Bangalore (IN); Murali Krishnan T M, Madurai (IN)

(73) Assignee: HONEYWELL INTERNATIONAL INC., Charlotte, NC (US)

(21) Appl. No.: 18/602,393

(22) Filed: Mar. 12, 2024

(30) Foreign Application Priority Data
Jan. 29, 2024 (IN) 202411005700

(51) Int. Cl. G08G 5/00; B64D 45/00

(52) U.S. Cl. CPC G08G 5/52; B64D 45/00; G08G 5/21; G08G 5/55

(57) ABSTRACT

Systems and methods are provided for promoting takeoff planning of an aircraft at an airport. The systems include a graphic user interface of a display device onboard the aircraft and a controller configured to, by one or more processors, receive airport data indicative of information relating to runways and runway/taxiway intersections of the airport, receive aircraft data indicative of information relating to the aircraft, receive environment data indicative of information relating to an environment exterior to the aircraft, display, on the graphic user interface, one or more selectable icons configured to allow a user to select one of the intersections of an assigned runway for takeoff, display, on the graphic user interface, takeoff information associated with the selected intersection, determine takeoff performance data indicative of the aircraft taking off from the selected intersection, and display, on the graphic user interface, the takeoff performance data.

### CROSS REFERENCE TO RELATED APPLICATION

This application claims priority to India Provisional Patent Application No. 20/241,1005700, filed Jan. 29, 2024, the entire content of which is incorporated by reference herein.

### TECHNICAL FIELD

The present invention generally relates to aircraft systems, and more particularly relates to systems and methods for promoting ease of runway/taxiway intersection takeoff assessment by determining and presenting takeoff parameters associated with selected intersections.

### BACKGROUND

For aircraft taking off at an airport, a departure from an intersection involves the aircraft initiating its takeoff roll from a location where a taxiway intersects the runway, rather than from the beginning of the runway. This practice is commonly employed to minimize the time an aircraft spends taxiing on the runway, thereby enhancing runway capacity and overall operational efficiency.

Executing a takeoff at an intersection demands careful planning and precise execution to uphold safety standards. Pilots must possess a thorough understanding of their aircraft's performance characteristics and limitations, as well as the specific procedures associated with conducting an intersection takeoff. The decision between opting for a full-length takeoff or an intersection takeoff is a crucial aspect of the decision-making process.

In instances where an intersection takeoff is being considered, a quick evaluation of takeoff performance computations is necessary to determine its safety for the various intersections along the runway. Although extremely rare, it is possible that pilots may mistakenly use the full runway length takeoff data, rather than the intersection takeoff data, during evaluation of intersection takeoff, for example, due to the significant workload associated with such assessment by the pilot.

Hence, there is a need for systems and methods that promote quick and accurate assessment of intersection takeoff options during takeoff of an aircraft. Furthermore, other desirable features and characteristics of the present invention will become apparent from the subsequent detailed description and the appended claims, taken in conjunction with the accompanying drawings and the foregoing technical field and background.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A method is provided for promoting takeoff planning of an aircraft at an airport. In one example, the method includes receiving, by a controller comprising one or more processors, airport data indicative of information relating to runways and runway/taxiway intersections of the airport, receiving, by the controller, aircraft data indicative of information relating to the aircraft, receiving, by the controller, environment data indicative of information relating to an environment exterior to the aircraft, displaying, on a graphic user interface of a display device onboard the aircraft, one or more selectable icons configured to allow a user to select one of the intersections of an assigned runway for takeoff, displaying, on the graphic user interface of the display device, takeoff information associated with the selected intersection, determining, by the controller, takeoff performance data indicative of the aircraft taking off from the selected intersection, and displaying, on the graphic user interface of the display device, the takeoff performance data.

A system is provided for promoting takeoff planning of an aircraft at an airport. In one example, the system includes a graphic user interface of a display device onboard the aircraft, and a controller configured to, by one or more processors, receive airport data indicative of information relating to runways and runway/taxiway intersections of the airport, receive aircraft data indicative of information relating to the aircraft, receive environment data indicative of information relating to an environment exterior to the aircraft, display, on the graphic user interface, one or more selectable icons configured to allow a user to select one of the intersections of an assigned runway for takeoff, display, on the graphic user interface, takeoff information associated with the selected intersection, determine takeoff performance data indicative of the aircraft taking off from the selected intersection, and display, on the graphic user interface, the takeoff performance data.

Furthermore, other desirable features and characteristics of the system and method will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 schematically represents a mobile platform and components of an intersection takeoff assessment system thereof in accordance with an embodiment;

FIG. 2 is a dataflow diagram illustrating operation of the intersection takeoff assessment system of FIG. 1 in accordance with an embodiment;

FIG. 3 is a flowchart illustrating an exemplary method for promoting ease of intersection takeoff assessment in accordance with an embodiment; and

FIGS. 4-7 include images illustrating various aspects of certain displays of a flight management system on a screen of a mobile platform in accordance with an embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Systems and methods disclosed herein provide for promoting quick and accurate assessments of intersection takeoff options during takeoff of a mobile platform. The mobile platform may be any type of vehicle, such as but not limited to various types of aircraft. It should be noted that the term aircraft, as utilized herein, may include any manned or unmanned object capable of flight. Examples of aircraft may include, but are not limited to, fixed-wing aerial vehicles (e.g., propeller-powered or jet powered), rotary-wing aerial vehicles (e.g., helicopters), manned aircraft, unmanned aircraft (e.g., unmanned aerial vehicles, or UAVs), delivery drones, etc. For convenience, the systems and methods will be described in reference to a manned airplane; however, as noted the systems and methods are not limited to such application.

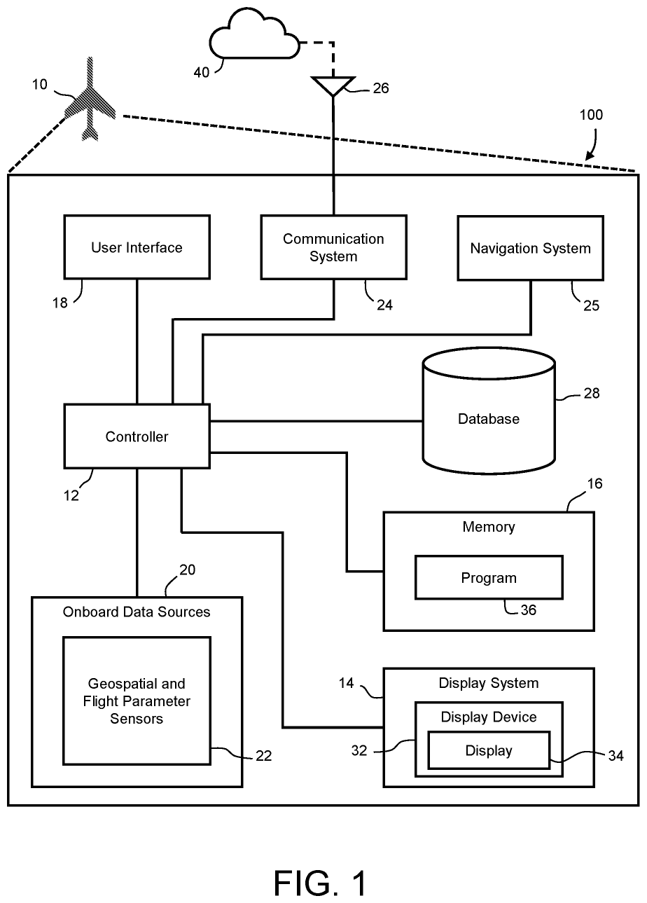

Referring now to FIG. 1, an aircraft 10 and certain systems thereof are illustrated in accordance with an exemplary and non-limiting embodiment of the present disclosure. An intersection takeoff assessment system 100 may be utilized onboard the aircraft 10 as described herein. As schematically depicted in FIG. 1, the system 100 includes and/or is functionally coupled to the following components or subsystems, each of which may assume the form of a single device or multiple interconnected devices, including, but not limited to, a controller 12 operationally coupled to: at least one display device 32, which may optionally be part of a larger on-board display system 14; computer-readable storage media or memory 16; a user interface 18, an onboard data sources 20 including, for example, an array of geospatial and flight parameter sensors 22, a navigation system 25, and one or more databases 28. The system 100 may be separate from or integrated within a flight management system (FMS) and/or a flight control system (FCS). The system 100 may also contain a communication system 24 including an antenna 26, which may wirelessly transmit data to and receive data from various external sources 40 physically and/or geographically remote to the system 100 and/or the aircraft 10.

Although schematically illustrated in FIG. 1 as a single unit, the individual elements and components of the system 100 can be implemented in a distributed manner utilizing any practical number of physically distinct and operatively interconnected pieces of hardware or equipment. When the system 100 is utilized as described herein, the various components of the system 100 will typically all be located onboard the aircraft 10.

The term “controller,” as appearing herein, broadly encompasses those components utilized to carry-out or otherwise support the processing functionalities of the system 100. Accordingly, the controller 12 can encompass or may be associated with any number of individual processors, flight control computers, navigational equipment pieces, computer-readable memories (including or in addition to the memory 16), power supplies, storage devices, interface cards, and other standardized components.

In various embodiments, the controller 12 includes at least one processor, a communication bus, and a computer readable storage device or media. The processor performs the computation and control functions of the controller 12. The processor can be any custom made or commercially available processor, a central processing unit (CPU), a graphics processing unit (GPU), an auxiliary processor among several processors associated with the controller 12, a semiconductor-based microprocessor (in the form of a microchip or chip set), any combination thereof, or generally any device for executing instructions. The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the processor is powered down. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 12. The bus serves to transmit programs, data, status and other information or signals between the various components of the aircraft 10. The bus can be any suitable physical or logical means of connecting computer systems and components. This includes, but is not limited to, direct hard-wired connections, fiber optics, infrared, and wireless bus technologies.

The instructions may include one or more separate programs, each of which comprises an ordered listing of executable instructions for implementing logical functions. The instructions, when executed by the processor, receive and process signals from the sensors 22, perform logic, calculations, methods and/or algorithms, and generate data based on the logic, calculations, methods, and/or algorithms. Although only one controller 12 is shown in FIG. 1, embodiments of the aircraft 10 can include any number of controllers 12 that communicate over any suitable communication medium or a combination of communication mediums and that cooperate to process the sensor signals, perform logic, calculations, methods, and/or algorithms, and generate data. In various embodiments, the controller 12 includes or cooperates with at least one firmware and software program (generally, computer-readable instructions that embody an algorithm) for carrying-out the various process tasks, calculations, and control/display functions described herein. During operation, the controller 12 may be programmed with and execute at least one firmware or software program, for example, a program 36, that embodies one or more algorithms, to thereby perform the various process steps, tasks, calculations, and control/display functions described herein.

The controller 12 may exchange data with one or more external sources 40 to support operation of the system 100 in various embodiments. In this case, bidirectional wireless data exchange may occur via the communication system 24 over a communications network, such as a public or private network implemented in accordance with Transmission Control Protocol/Internet Protocol architectures or other conventional protocol standards. Encryption and mutual authentication techniques may be applied, as appropriate, to ensure data security.

In various embodiments, the communication system 24 is configured to support instantaneous (i.e., real time or current) communications between on-board systems, the controller 12, and the one or more external sources 40. The communication system 24 may incorporate one or more transmitters, receivers, and the supporting communications hardware and software required for components of the system 100 to communicate as described herein. In various embodiments, the communication system 24 may have additional communications not directly relied upon herein, such as bidirectional pilot-to-ATC (air traffic control) communications via a datalink, and any other suitable radio communication system that supports communications between the aircraft 10 and various external source(s).

The memory 16 can encompass any number and type of storage media suitable for storing computer-readable code or instructions, such as the program 36, as well as other data generally supporting the operation of the system 100. As can be appreciated, the memory 16 may be part of the controller 12, separate from the controller 12, or part of the controller 12 and part of a separate system. The memory 16 can be any suitable type of storage apparatus, including various different types of direct access storage and/or other memory devices.

A source of information suitable for operating one or more systems of the aircraft 10 may be part of the system 100. In certain embodiments, the source is the one or more databases 28 employed to receive and store map data, which may be updated on a periodic or iterative basis to ensure data timeliness. In various embodiments, the map data may include various terrain and manmade object locations and elevations and may be stored in the memory 16 or in the one or more databases 28, and referenced by the program 36. In various embodiments, these databases 28 may be available online and accessible remotely by a suitable wireless communication system, such as the communication system 24.

The sensors 22 supply various types of data and/or measurements to the controller 12. In various embodiments, the sensors 22 supply, without limitation, one or more of: inertial reference system measurements providing a location, Flight Path Angle (FPA) measurements, airspeed data, groundspeed data, vertical speed data, vertical acceleration data, altitude data, attitude data including pitch and roll measurements, yaw data, data related to ownship weight, time/date information, heading information, data related to atmospheric conditions, flight path data, flight track data, radar altitude data, geometric altitude data, wind speed and direction data. Further, in certain embodiments of the system 100, the controller 12, and the other components of the system 100 may be included within or cooperate with any number and type of systems commonly deployed onboard aircraft including, for example, an FMS, an Attitude Heading Reference System (AHRS), an Instrument Landing System (ILS), and/or an Inertial Reference System (IRS).

With continued reference to FIG. 1, the display device 32 can include any number and type of image generating devices on which one or more avionic displays 34 may be produced. In various embodiments, the display device 32 may be affixed to the static structure of the aircraft 10 cockpit as, for example, a Head Down Display (HDD) or Head Up Display (HUD) unit. Alternatively, the display device 32 may assume the form of a movable display device (e.g., a pilot-worn display device) or a portable display device, such as an Electronic Flight Bag (EFB), a laptop, or a tablet computer carried into the aircraft 10 cockpit by a pilot.

At least one avionic display 34 is generated on display device 32 during operation of the system 100. The term “avionic display” as used herein is synonymous with the terms “aircraft-related display” and “cockpit display” and encompasses displays generated in textual, graphical, cartographical, and other formats. The system 100 can generate various types of lateral and vertical avionic displays 34 on which symbology, text annunciations, and other graphics pertaining to flight planning are presented for a pilot to view. The display device 32 is configured to continuously render at least one avionic display 34 showing a terrain environment at a current location of the aircraft 10. The avionic display 34 generated and controlled by the system 100 can include alphanumerical input displays of the type commonly presented on the screens of multi-function control and display units (MCDUs), as well as Control Display Units (CDUs) generally. Specifically, certain embodiments of the avionic displays 34 include one or more two dimensional (2D) avionic displays, such as a horizontal (i.e., lateral) navigation display or vertical navigation display; and/or on one or more three dimensional (3D) avionic displays, such as a Primary Flight Display (PFD) or an exocentric 3D avionic display.

In various embodiments, a human-machine interface, such as a touch screen display, is implemented as an integration of the user interface 18 and the display device 32. Via various display and graphics systems processes, the controller 12 may command and control the touch screen display generating a variety of graphical user interface (GUI) objects or elements, for example, buttons, sliders, and the like, which are used to prompt a user to interact with the human-machine interface to provide user input, and to activate respective functions and provide user feedback, responsive to received user input at the GUI element.

The navigation system 25 can provide navigation data associated with the aircraft's current position and movement direction (e.g., heading, course, track, etc.) to the controller 12. As such, the navigation system 25 can include, for example, an inertial navigation system, a satellite navigation system (e.g., Global Positioning System) receiver, VLF/OMEGA, Loran C, VOR/DME, DME/DME, IRS, aircraft attitude sensors, or the navigation information can come from a flight management system. The navigation data provided to the controller 12 can also include information about the aircraft's airspeed, ground speed, altitude (e.g., relative to sea level), pitch, and other important flight information. In any event, for this example embodiment, the navigation system 25 can include any suitable position and direction determination devices that are capable of providing the controller 12 with at least an aircraft's current position (e.g., in latitudinal and longitudinal form), the real-time direction (heading, course, track, etc.) of the aircraft in its path, and other important flight information (e.g., airspeed, altitude, pitch, attitude, etc.).

The system 100 is configured to assist the pilot in assessing intersection takeoff options by determining and presenting intersection takeoff performance with respect to pilot selected runway-taxiway intersections of planned or offered runways. In various examples, the system 100 displays a list of intersections available on a runway. Upon selection by the pilot of a particular intersection from the list, the system 100 displays relevant information associated with the selected intersection such as remaining runway length, elevation of runway-taxiway intersection from the airport database, etc. In various examples, the system 100 may provide various recommendations and/or alerts associated with the intersection takeoff options.

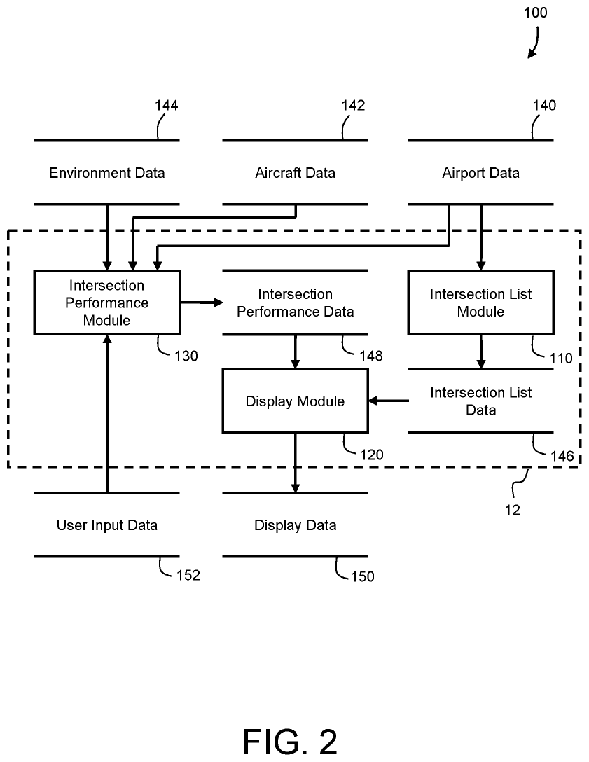

With reference to FIG. 2 and with continued reference to FIG. 1, a dataflow diagram illustrates elements of the system 100 of FIG. 1 in accordance with various embodiments. As can be appreciated, various embodiments of the system 100 according to the present disclosure may include any number of modules embedded within the controller 12 which may be combined and/or further partitioned to similarly implement systems and methods described herein. Furthermore, inputs to the system 100 may be received from other control modules (not shown) associated with the aircraft 10, and/or determined/modeled by other sub-modules (not shown) within the controller 12. Furthermore, the inputs might also be subjected to preprocessing, such as sub-sampling, noise-reduction, normalization, feature-extraction, missing data reduction, and the like. In various embodiments, the system 100 includes an intersection list module 110, a display module 120, and an intersection performance module 130.

In various embodiments, the intersection list module 110 receives as input airport data 140 retrieved from the one or more external sources 40 and/or the one or more databases 28. The airport data 140 includes various data indicative of information relating to runways and runway/taxiway intersections of the airport (e.g., lengths of the runways, positions of the intersections along the runways, slope, elevation, etc.). The intersection list module 110 processes the airport data 140 and generates a list of the intersections of the runways of the airport. The intersection list module 110 generates intersection list data 146 that includes various data indicating the list of the intersections.

In various embodiments, the display module 120 receives as input the intersection list data 146 generated by the intersection list module 110. The display module 120 generates display data 150 that includes various data indicating the list of intersections in a format readable by, for example, the display devices 32 and/or the display system 14. The display module 120 may transmit the display data 150 to the display system 14 and/or the display device 32 for display of the list of intersections on the display 34.

In various embodiments, once the pilot has selected from the list of intersections with the user interface 18, the intersection performance module 130 receives as input user input data 152 indicative of the selection. In various embodiments, the intersection performance module 130 receives as input the airport data 140 retrieved from the one or more external sources 40 and/or the one or more databases 28. In various embodiments, the intersection performance module 130 receives as input aircraft data 142 retrieved from the one or more databases 28 and/or manually input by, for example, the pilot via the user interface 18. The aircraft data 132 includes various data indicative of information relating to the aircraft 10 (e.g., aircraft weight, flaps position, thrust reversers, anti-ice, brakes, etc.). In various embodiments, the intersection performance module 130 receives as input environment data 144 retrieved from the one or more external sources 40 and/or the one or more databases 28, or manually input by, for example, the pilot via the user interface 18. The environment data 134 includes various data indicative of information relating to an environment exterior to the aircraft 10 (e.g., obstacles, temperature, wind, runway conditions, etc.).

The intersection performance module 130 processes the airport data 140, the aircraft data 142, the environmental data 144, and/or the user input data 152, performs an analysis to determine takeoff performance parameters associated with the aircraft 10 taking off from the selected intersection (e.g., V-speeds (V_{R}, V₂, V_{S}, V_{REF}) required thrust settings, required runway length, etc.). The intersection performance module 130 generates intersection performance data 148 that includes various data indicative of the takeoff performance parameters and indicative of various takeoff information associated with the selected intersection (e.g., heading, remaining length of runway from intersection, elevation, threshold, slope, etc.).

As used herein, V-speeds refers to various airspeeds defined for specific maneuvers in specific aircraft at specific configurations (e.g., flaps, gear). Various examples include V-speeds as defined in Title 14 Code of Federal Regulations, parts 1, 23, and 25. Specific examples include V_{R} which refers to a rotation speed, that is, the speed at which a pilot makes a control input, with the intention of lifting the aircraft out of contact with the runway, V₂ which refers to a takeoff safety speed, V_{S} which refers to a stalling speed, or the minimum steady flight speed at which the airplane is controllable, in other words, the airplane will stall if you fly any slower than this speed, and V_{REF} which refers to a reference landing speed.

In various embodiments, the display module 120 receives as input the intersection performance data 148 generated by the intersection performance module 130. The display module 120 generates the display data 150 that includes various data indicative of the takeoff performance parameters and the takeoff information in a format readable by, for example, the display devices 32 and/or the display system 14. The display module 120 may transmit the display data 150 to the display system 14 and/or the display device 32 for display of the takeoff performance parameters and the takeoff information on the display 34.

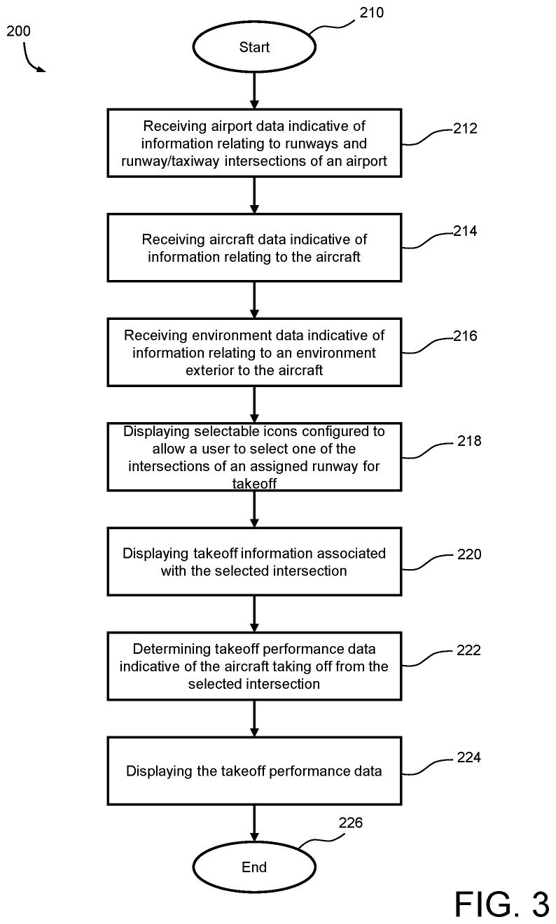

The systems disclosed herein, including the system 100, provide for methods of assisting with assessing intersection takeoff options. For example, FIG. 3 is a flowchart illustrating an exemplary method 200 for determining and presenting intersection takeoff performance parameters with respect to pilot selected runway-taxiway intersections.

In various embodiments, the method 200 may start at 210. At 212, the method 200 may include receiving, by a controller comprising one or more processors, airport data indicative of information relating to runways and runway/taxiway intersections of an airport (e.g., lengths of the runways, positions of the intersections along the runways, slope, elevation, etc.).

At 214, the method 200 may include receiving, by the controller, aircraft data indicative of information relating to the aircraft (e.g., aircraft weight, flaps position, thrust reversers, anti-ice, brakes, etc.). At 216, the method 200 may include receiving, by the controller, environment data indicative of information relating to an environment exterior to the aircraft (e.g., obstacles, temperature, wind, runway conditions, etc.).

At 218, the method 200 may include displaying, on a graphic user interface of a display device onboard the aircraft, selectable icons configured to allow a user to select one of the intersections of an assigned runway for takeoff. At 220, the method 200 may include displaying, on the graphic user interface of the display device, takeoff information associated with the selected intersection (e.g., heading, remaining length of runway from intersection, elevation, threshold, slope, etc.).

At 222, the method 200 may include determining, by the controller, takeoff performance data indicative of the aircraft taking off from the selected intersection (e.g., V-speeds (V₁, V_{R}, V₂, V_{S}, V_{REF}), required thrust settings, required runway length, etc.). At 224, the method 200 may include displaying, on the graphic user interface of the display device, the takeoff performance data. The method 200 may end at 226.

In various embodiments, the method 200 may further include determining, by the controller, whether the selected intersection is a viable takeoff location, and displaying, on the graphic user interface of the display device, an indication of whether the selected intersection is a viable takeoff location. In various embodiments, the method 200 may further include generating an alert automatically in response to the aircraft entering or approaching an intersection while takeoff information set in the controller (e.g., total runway length) is different from the takeoff information of the intersection (e.g., remaining runway length from intersection). In various embodiments, the method 200 may include determining, by the controller, a recommendation for a takeoff location from amongst the intersections based on the takeoff performance data, and displaying, on the graphic user interface of the display device, an indication of the recommendation (e.g., color coded icons).

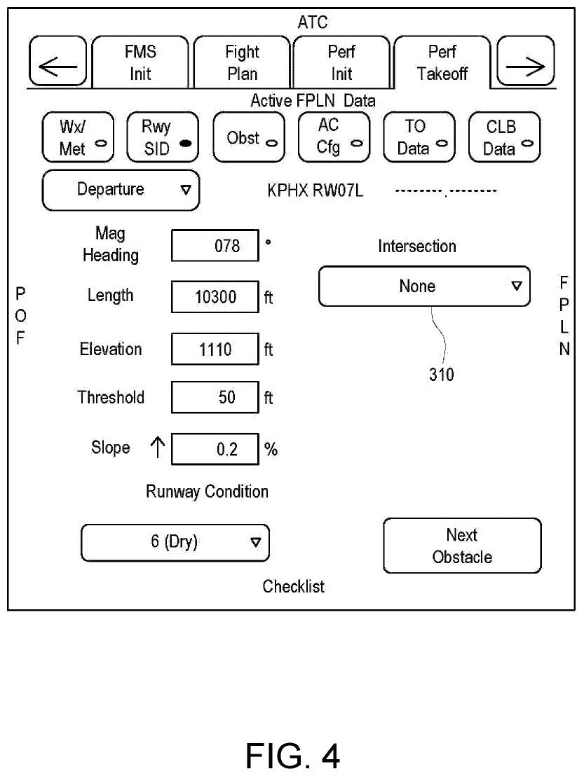

FIGS. 4-8 present exemplary images illustrating various aspects of the system 100 and/or the method 200. The images present a graphic user interface of a nonlimiting flight management system, and in particular, a runway page, a takeoff page, and certain subpages thereof.

FIG. 4 presents various information associated with a selected, planned, or offered runway of an airport. An intersection icon 310 is provided that a user may interact with to select a taxiway/runway intersection of the runway. In FIG. 4, the intersection icon displays “none” indicating that an intersection is not currently selected. In some examples, this may be a default setting. While no intersection is selected, the full length runway information of the runway is presented.

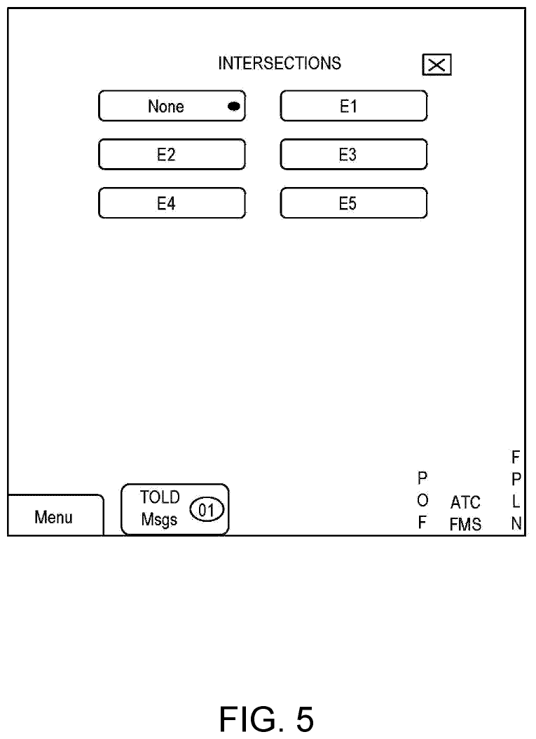

FIG. 5 presents a menu of available intersections that may be selectively chosen by the user. In some examples, the menu may be displayed in response to the user interacting with the intersection icon 310. In this nonlimiting example, the available intersections are designated as E1, E2, E3, E4, and E5. The designations of the intersections may correspond to identifiers of the intersections as stored in one or more airport databases (e.g., as identified on an airport chart).

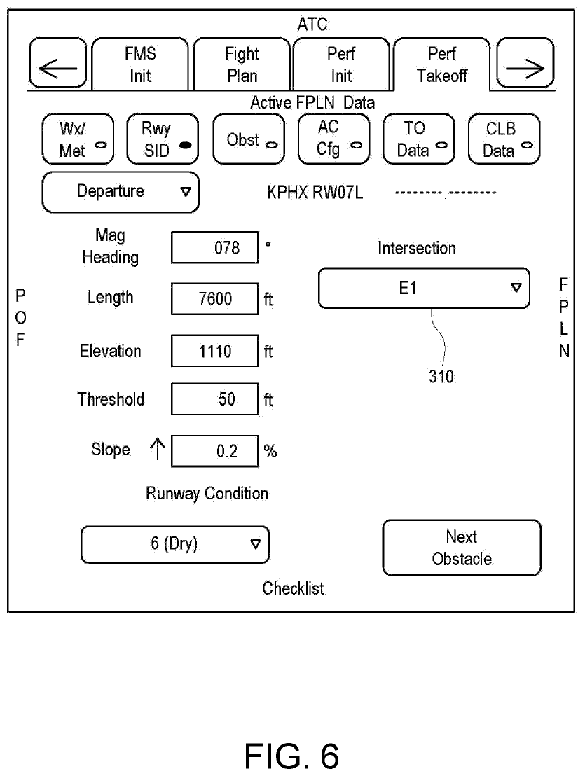

FIG. 6 presents the runway page previously shown in FIG. 4. In FIG. 6, the user has selected the intersection designated E1 as shown in the intersection icon 310. In response the system replaces the information previously associated with the full-length runway with information associated with the selected intersection. In this example, the runway page reflects the length of the runway from the selected intersection, elevation, slope, threshold, etc. for selected runway-taxiway intersection.

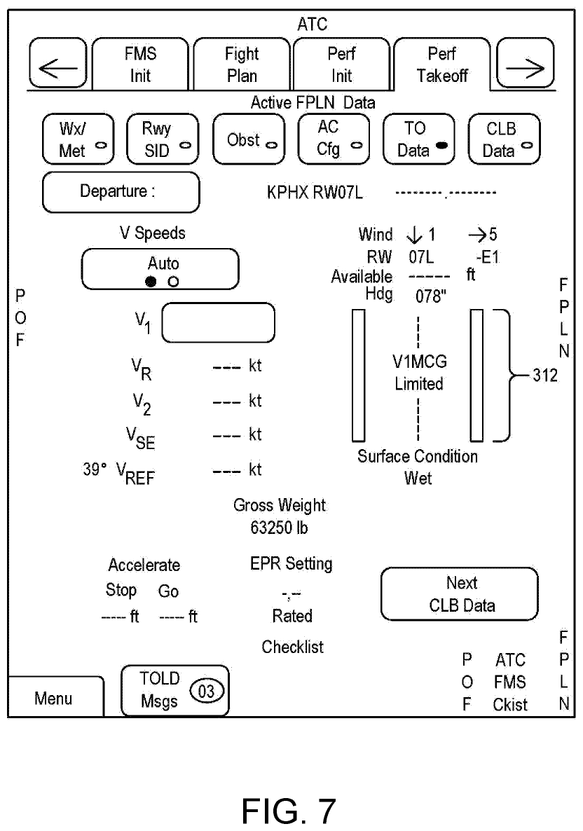

FIG. 7 presents the takeoff page including various information associated with takeoff performance determined for either a full length runway or a runway-taxiway intersection, depending on which is selected. In this example, the takeoff page may be accessed by a user selecting the takeoff page tab in the upper portion of the display. Various takeoff performance information may be presented. In the example of FIG. 7, the takeoff performance information includes certain V-speeds (e.g., V₁, V_{R}, V₂, V_{SE}, and VREF) and environmental conditions such as wind direction, wind speed, and runway surface conditions (e.g., wet, dry, etc.). Notably, in FIG. 7 the takeoff performance information is not populated in the corresponding fields. In this example, the system 100 determined that takeoff from the selected intersection is not possible. In various examples, the outcome of the determination may be indicated in the takeoff page or elsewhere. For example, FIG. 7 shows the intersection (V1MCG) as limited. In addition, one or more icons, such as a runway icon 312, may be color coded. For example, the runway icon 312 may be green for a suitable runway/intersection, the runway icon 312 may be amber for a limited runway/intersection, and the runway icon 312 may be red for an unsuitable or dangerous runway or intersection. In some examples, the system 100 may generate an alert, notification, or alarm in response to a determination that the aircraft 10 is approaching a limited or unsuitable runway or intersection. In some examples, the system 100 may generate an alert, notification, or alarm in response to a determination that the aircraft 10 is approaching or entering a runway or intersection while the takeoff performance information presented in the system 100 does not match the runway or intersection. For example, the alert, notification, or alarm may be generated when the aircraft 10 enters an intersection while the takeoff parameter information presents full length runway settings.

The systems and methods disclosed herein provide various benefits over certain existing systems and methods. For example, the systems and methods provide a capability for a user, such as a pilot of an aircraft, to easily switch between full length takeoff and intersection takeoff parameters, or to switch between multiple intersections, to assess the takeoff performance data. This capability promotes ease of decision-making during intersection takeoff assessment and may reduce a likelihood of errors.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

As used herein, the term “substantially” denotes within 5% to account for manufacturing tolerances. Also, as used herein, the term “about” denotes within 5% to account for manufacturing tolerances.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for promoting takeoff planning of an aircraft at an airport, the method comprising:
receiving, by a controller comprising one or more processors, airport data indicative of information relating to runways and runway/taxiway intersections of the airport;
receiving, by the controller, aircraft data indicative of information relating to the aircraft;
receiving, by the controller, environment data indicative of information relating to an environment exterior to the aircraft;
displaying, on a graphic user interface of a display device onboard the aircraft, one or more selectable icons configured to allow a user to select one of the intersections of an assigned runway for takeoff;
displaying, on the graphic user interface of the display device, takeoff information associated with a selected intersection;
determining, by the controller, takeoff performance data indicative of the aircraft taking off from the selected intersection; and
displaying, on the graphic user interface of the display device, the takeoff performance data.

2. The method of claim 1, further comprising:
determining, by the controller, whether the selected intersection is a viable takeoff location; and
displaying, on the graphic user interface of the display device, an indication of whether the selected intersection is a viable takeoff location.

3. The method of claim 1, further comprising generating an alert automatically in response to the aircraft entering or approaching an intersection while takeoff information set in the controller is different from the takeoff information of the intersection.

4. The method of claim 1, further comprising:
determining, by the controller, a recommendation for a takeoff location from amongst the intersections based on the takeoff performance data; and
displaying, on the graphic user interface of the display device, an indication of the recommendation.

5. The method of claim 4, wherein the indication of the recommendation includes a color coded icon.

6. The method of claim 1, wherein the airport data includes a length of a runway, a position of an intersection along the runway, a slope of the runway at the intersection, and an elevation of the runway at the intersection.

7. The method of claim 1, wherein the aircraft data includes a weight of the aircraft, positions of flaps of the aircraft, a status of thrust reversers of the aircraft, a status of an anti-ice system of the aircraft, and a status of brakes of the aircraft.

8. The method of claim 1, wherein the environment data includes obstacles, temperature, wind conditions, and runway conditions.

9. The method of claim 1, wherein the takeoff information includes a heading of the aircraft, a remaining length of a runway from an intersection, an elevation of the runway from the intersection, and a slope of the runway from the intersection.

10. The method of claim 1, wherein the takeoff performance data includes V₁, V_{R}, V₂, V_{S}, V_{REF}, required thrust settings, and required takeoff distance.

11. A system for promoting takeoff planning of an aircraft at an airport, the system comprising:
a graphic user interface of a display device onboard the aircraft; and
a controller configured to, by one or more processors:
receive airport data indicative of information relating to runways and runway/taxiway intersections of the airport;
receive aircraft data indicative of information relating to the aircraft;
receive environment data indicative of information relating to an environment exterior to the aircraft;
display, on the graphic user interface, one or more selectable icons configured to allow a user to select one of the intersections of an assigned runway for takeoff;
display, on the graphic user interface, takeoff information associated with a selected intersection;
determine takeoff performance data indicative of the aircraft taking off from the selected intersection; and
display, on the graphic user interface, the takeoff performance data.

12. The system of claim 11, wherein the controller is configured to, by the one or more processors:
determine whether the selected intersection is a viable takeoff location; and
display, on the graphic user interface, an indication of whether the selected intersection is a viable takeoff location.

13. The system of claim 11, wherein the controller is configured to, by the one or more processors, generate an alert automatically in response to the aircraft entering or approaching an intersection while takeoff information set in the controller is different from the takeoff information of the intersection.

14. The system of claim 11, wherein the controller is configured to, by the one or more processors:
determine a recommendation for a takeoff location from amongst the intersections based on the takeoff performance data; and
display, on the graphic user interface, an indication of the recommendation.

15. The system of claim 14, wherein the indication of the recommendation includes a color coded icon.

16. The system of claim 11, wherein the airport data includes a length of a runway, a position of an intersection along the runway, a slope of the runway at the intersection, and an elevation of the runway at the intersection.

17. The system of claim 11, wherein the aircraft data includes a weight of the aircraft, positions of flaps of the aircraft, a status of thrust reversers of the aircraft, a status of an anti-ice system of the aircraft, and a status of brakes of the aircraft.

18. The system of claim 11, wherein the environment data includes obstacles, temperature, wind conditions, and runway conditions.

19. The system of claim 11, wherein the takeoff information includes a heading of the aircraft, a remaining length of a runway from an intersection, an elevation of the runway from the intersection, and a slope of the runway from the intersection.

20. The system of claim 11, wherein the takeoff performance data includes V₁, V_{R}, V₂, V_{S}, V_{REF}, required thrust settings, and required takeoff distance.
